(19) United States
(12) Patent Application Publication
(10) Pub. No.: US 2022/0399990 A1
(43) Pub. Date: Dec. 15, 2022

(54) KEY MANAGEMENT DEVICE AND KEY MANAGEMENT METHOD

(71) Applicant: Faurecia Clarion Electronics Co., Ltd., Saitama-shi, Saitama (JP)

(72) Inventors: Kyosuke OCHIAI, Saitama (JP); Satoshi OBATA, Saitama (JP)

(73) Assignee: Faurecia Clarion Electronics Co., Ltd., Saitama-shi, Saitama (JP)

(21) Appl. No.: 17/776,357

(22) PCT Filed: Oct. 8, 2020
(86) PCT No.: PCT/JP2020/038217

§ 371 Date: May 12, 2022

(30) Foreign Application Priority Data
Nov. 14, 2019 (JP) 2019-206363

(51) Int. Cl. H04L 9/08

(52) U.S. Cl. CPC H04L 9/083; H04L 9/0894; H04L 9/0825

(57) ABSTRACT

A key management unit causes key data being managed to be stored, with prescribed timing, in a second address that is different from a first address that indicates the location in which the key data is stored, and updates the first address of key address management information to the second address. A cryptographic processing unit transmits, to the key management unit address, request information requesting the address of the key data for carrying out a cryptographic process on a prescribed message. Upon receipt of the address request information, the key management unit acquires the address of the key data from key address management information and transmits the address to the cryptographic processing unit. Upon receipt of the address, the cryptographic processing unit accesses the address to use the key data to carry out a cryptographic process on the message.

### FIELD OF TECHNOLOGY

The present invention, in general, relates to a technology for managing keys used in a cryptographic process.

### BACKGROUND ART

Conventionally, when communicating device control information, secret corporate information, personal information, and the like, a data cryptography process is carried out, using key data, in order to prevent tampering and to prevent wiretapping, interception, and the like, by third parties. In the below, a third party that engages in illegal behavior, or the like, by pretending to be a legitimate user shall be termed an “unauthorized user.” The secrecy of an encrypted message may be compromised through transferring key data to an unauthorized user, so control of key data is extremely important.

In regard to this point, in a device and system for carrying out control communication, a key management device wherein key data updating and key data generation control are carried out autonomously by individual devices has been disclosed (referencing Patent Document 1).

### PRIOR ART DOCUMENTS

### Patent Documents

Patent Document 1: Japanese Unexamined Patent Application Publication 2015-142301

### SUMMARY OF THE INVENTION

### Problem Solved by the Present Invention

In the technology set forth in Patent Document 1, since it is necessary to change the key data sequentially, control of the key data is complicated.

The present invention was created in contemplation of the point set forth above, and proposes a key management device, and the like, for managing key data appropriately, doing so without changing the key data.

### Means for Resolution

In order to solve this issue, the present invention is a key management device for managing key data used in cryptographic processing of a message, comprising: a key management unit for managing key data using key address management information that includes an address indicating a location wherein key data is stored; and a cryptographic processing unit for performing a cryptographic process on a message using the key data that is managed by the key management unit, wherein: the key management unit stores the managed key data at a second address with prescribed timing, the second address is different from a first address that indicates a location wherein the key data is stored, and updates the first address in the key address management information to the second address; the cryptographic processing unit transmits address request information for requesting the key data address to the key management unit in order to perform cryptographic processing on a prescribed message; the key management unit, upon receipt of the address request information, acquires the key data address from the key address management information, and transmits the acquired key data address to the cryptographic processing unit; and the cryptographic processing unit, upon receipt of the address, performs cryptographic processing on the message by accessing the address and using the key data.

### Effects of the Invention

The present invention enables appropriate management of key data used in cryptographic processing.

### BRIEF DESCRIPTIONS OF THE DRAWINGS

FIG. 1 is a diagram showing an example of a structure for a key management device according to a first embodiment.

FIG. 2 is a diagram showing an example of key address management information.

FIG. 3 is a diagram showing an example of a flow of a series of processes in the key management device.

FIG. 4 is a diagram showing an example of a flowchart relating to a key registering process.

FIG. 5 is a diagram showing an example of a flowchart relating to a key moving process.

FIG. 6 is a diagram showing an example of a flowchart relating to a key address acquiring process.

FIG. 7 is a diagram showing an example of a flowchart relating to a cryptographic process.

FIG. 8 is a diagram for explaining moving of key data.

### FORMS FOR CARRYING OUT THE PRESENT INVENTION

An embodiment according to the present invention will be explained in detail below, using the drawings.

### (1) First Embodiment

The present embodiment relates to a technology for appropriate management of key data that are used in cryptographic processing. A cryptographic process is a process for encrypting or decrypting a message. The message may be any type of data that is exchanged in a communication (data relating to a communication), such as a command, a response, or the like.

For example, the key management device according to the present embodiment changes, with prescribed timing, the location at which key data, used in cryptographic processing, is stored. This structure makes it difficult for an unauthorized user to find key data.

Note that, in the explanation below, in cases of explanations wherein there is no need to discriminate between similar elements, the shared part (the part excluding the suffix) of reference symbols that include suffixes may be used, and in explanations wherein identical elements are to be distinguished from each other, reference symbols that include the suffixes may be used. For example, when intervals are explained without distinguishing between them, the description may be “interval 800,” but when the explanation distinguishes between each of the intervals, the descriptions might be “interval 800-1,” and “interval 800-2.”

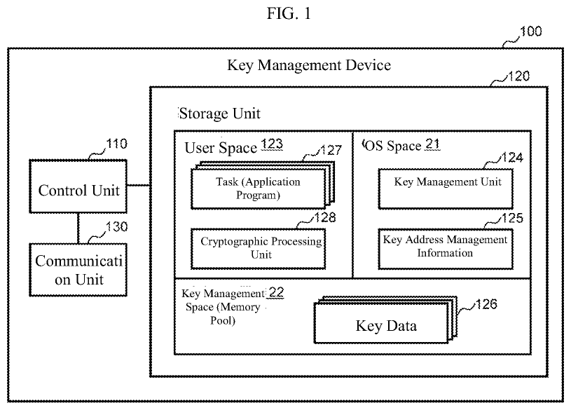

FIG. 1 is a diagram showing an example of a structure for a key management device 100.

The key management device 100 is, for example, a personal computer, a server machine, a control device that is provided on a circuit board of an electronic product, an ECU (electronic control unit), or the like. The key management device 100 is structured including a control unit 110, a storage unit 120, and a communication unit 130.

The control unit 110 is one or more processors. At least one processor is typically a microprocessor such as a CPU (central processing unit), but may be another type of processor, such as a GPU (graphics processing unit). The at least one processor may be of a single core or may be multicored. The at least one processor is a processor in a broad definition thereof, such as a hardware circuit (for example, an FPGA [[field-programmable gate array]] or an ASIC [[application-specific integrated circuit]]) for carrying out some or all of the processes.

The storage unit 120 is one or more memories, and typically may be a main storage device.

The one or more memories in a memory unit may be a volatile memory such as a RAM (random access memory) or a non-volatile memory such as a ROM (read-only memory).

The storage unit 120 is structured including an OS space 121, a key management space 122, and a user space 123.

The OS space 121 is a storage region of the storage unit 120 that is used by an OS (operating system) that is provided in the key management device 100. The data in the OS space 121 is structured so as to enable access by the OS, and to deny access by programs that operate under the OS (in the user space 123). For example, the OS provides the key management unit 124. Note that the other functions of the OS are omitted from the diagrams.

The key management unit 124 uses key address management information 125 that is stored in the OS space 121 to control the key data 126 that is stored in the key management space 122.

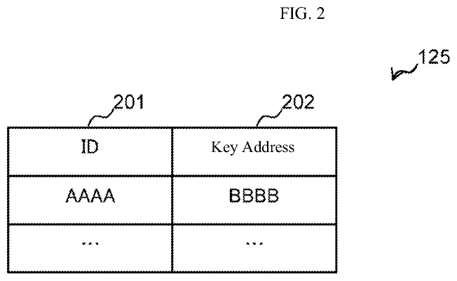

The key data 126 is data (symbols) used in cryptographic processing of messages, for example, described below, and for controlling processing of an encrypting algorithm. The key data 126 may be key data used in common key cryptography, may be key data used in public key cryptography, or may be key data used in another form of cryptography. Note that the key address management information 125 will be described below, using FIG. 2.

The key management space 122 is a storage region (a memory pool), having a prescribed size secured from an empty storage region in the storage unit 120, for storing the key data 126. One or more key data 126 is stored in a prescribed location in the key management space 122.

The user space 123 is a storage region of the storage unit 120 that is assigned under OS control when a program (a task 127, a cryptographic processing unit 128, or the like) is started under OS control.

The task 127 is an application program for carrying out a prescribed process, and one or more tasks 127 are executed in the key management device 100. The task 127 may be a transmission-side program, a reception-side program, or another program. A transmission-side program is a program that requests a cryptographic processing unit 128 to encrypt a message that requires encryption in order to communicate outside of the task 127. A reception-side program is a program that requests a cryptographic processing unit 128 to decrypt an encrypted message that has been received from the outside. The “another program” is a program that carries out communication outside of the task 127.

In the present embodiment, the explanation will use a case wherein the task 127 is a transmission-side program and the cryptographic process carried out by the cryptographic processing unit 128 is encryption. Note that the method for controlling the key data 126 would be fundamentally the same for a case wherein the task 127 is a reception-side program and the cryptographic process carried out by the cryptographic processing unit 128 is decrypting, so no explanation thereof is given below.

“Outside of the task 127” (hereinafter termed “outside”) refers to that which is other than the task 127, such as another function within the key management device 100 (another task 127, a cryptographic processing unit 128, the OS, or the like), a device other than the key management device 100, or the like.

In addition, the key data 126 may be provided corresponding to individual tasks 127, or may be provided in common for a plurality of tasks 127. The present embodiment will use, as an example, a case wherein key data 126 is provided for each individual task 127.

The cryptographic processing unit 128 is a secure program that is protected technologically so as to not be affected by interferences, such as attacks, interception, tempering, or the like, by unauthorized users. The cryptographic processing unit 128 carries out communication with a task 127 that has been evaluated as being a legitimate program. For example, the cryptographic processing unit 128, when the task 127 is started, stores (registers) information for identifying the task 127 (a task ID that is assigned and controlled by the OS), and uses the identifying information, when a connection is requested by a task 127, to carry out authentication that the program is legitimate, communicating with the task 127 if the authentication is successful.

The cryptographic processing unit 128 uses the key data 126 to encrypt the message that was requested by the task 127, and returns the encrypted message to the task 127 that requested the encryption. Note that the key management unit 124 communicates with the cryptographic processing unit 128, which is a secure program, but does not communicate with the task 127.

The communication unit 130 is a communication interface device compatible with a LAN (local area network), a CAN (controller area network), MOST (media-oriented systems transport), or the like, and controls communication with prescribed devices other than the key management device 100.

FIG. 2 is a diagram showing an example of key address management information 125.

The key address management information 125 includes information defining correspondence between IDs 201 and key addresses 202.

An ID 201 is identifying information enabling identification of a task 127. An ID 201 is, for example, assigned to each task 127 by the key management unit 124 to enable the key management unit 124 to manage the key data 126 (key management).

The key address 202 is information indicating the location in the key management space 122 wherein the key data 126 is stored. The key address 202 is a physical address used for the cryptographic processing unit 128 to access the key data 126. Note that while the details are described below, the locations of the key data 126 to be accessed are changed (for example, moved) with prescribed timing by the key management unit 124, for example, and the information for the key addresses 202 is updated, with the prescribed timing, by the key management unit 124.

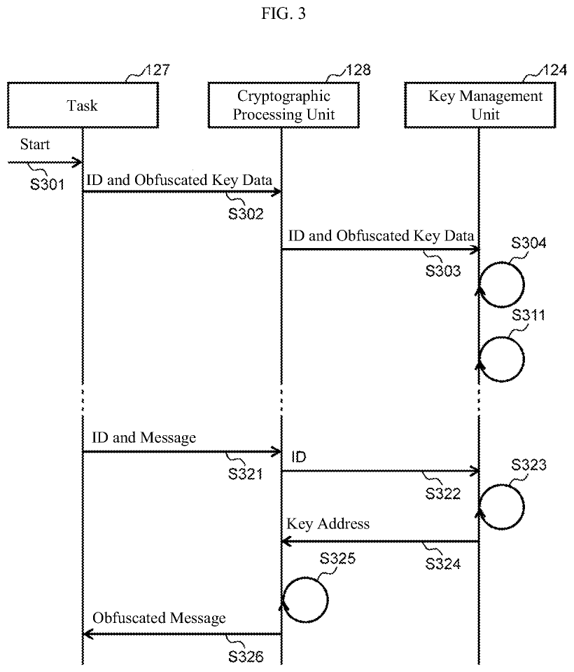

FIG. 3 is a diagram showing an example of the flow of the series of processes in the key management device 100.

(Key Registering Process)

The key registering process will be explained first using Step S301 through Step S304.

When the key management device 100 is started (Step S301), task 127 sends, to the cryptographic processing unit 128, the ID that is assigned to the task 127 for key management by the key management unit 124 and hard-coded (that is, written in advance in the source code of the task 127) key data 126 that has been obfuscated (hereinafter termed “obfuscated key data”) (Step S302).

The cryptographic processing unit 128, upon receipt of the ID and obfuscated key data received from the task 127, sends the ID and obfuscated key data to the key management unit 124 (Step S303).

The key management unit 124, upon receipt of the ID and obfuscated key data from the cryptographic processing unit 128, carries out a key registering process (Step S304). In the key registering process, the obfuscation is removed from the obfuscated key data to produce the key data 126, which is stored in the key management space 122 of the storage unit 120. Note that the key registering process is described below using FIG. 4.

(Key Moving Process)

The key moving process will be explained next using Step S311.

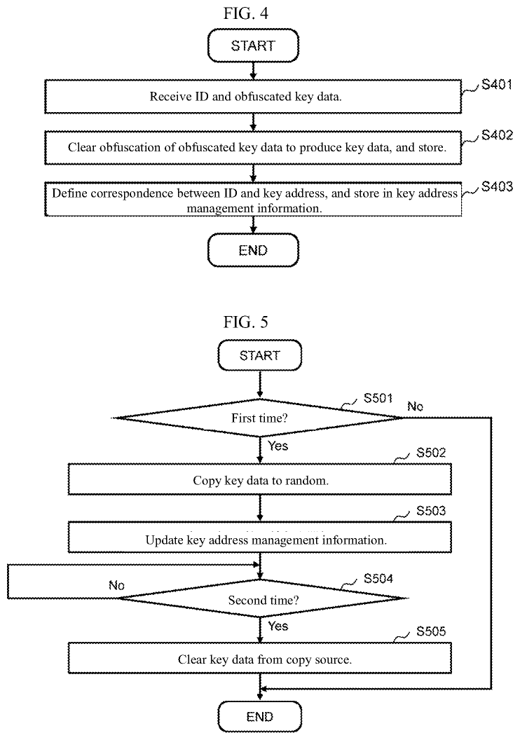

The key management unit 124, when the key data 126 is stored in the key management space 122 of the storage unit 120, carries out a key moving process with prescribed timing (Step S311). The key data 126 is moved by the key moving process. Note that the key moving process will be described below using FIG. 5.

(Cryptographic Process)

The cryptographic process will be explained next using Step S321 through Step S326.

The task 127, when sending a message to the outside, sends, to the cryptographic processing unit 128, the message and the ID that is assigned to the task 127 (Step S321).

The cryptographic processing unit 128, upon receipt of the ID and message sent from the task 127, sends the ID to the key management unit 124, as address request information for requesting the address of the key data 126 (hereinafter termed the “key address”) (Step S322). Note that the cryptographic processing unit 128 need not send the ID if there is only a single task 127 (key data 126).

The key management unit 124, upon receipt of the ID (address request information) sent from the cryptographic processing unit 128, carries out a key address acquiring process (Step S323). The key address is acquired by the key address acquiring process. Note that the key address acquiring process will be described below using FIG. 6.

The key management unit 124 sends the acquired key address to the cryptographic processing unit 128 (Step S324).

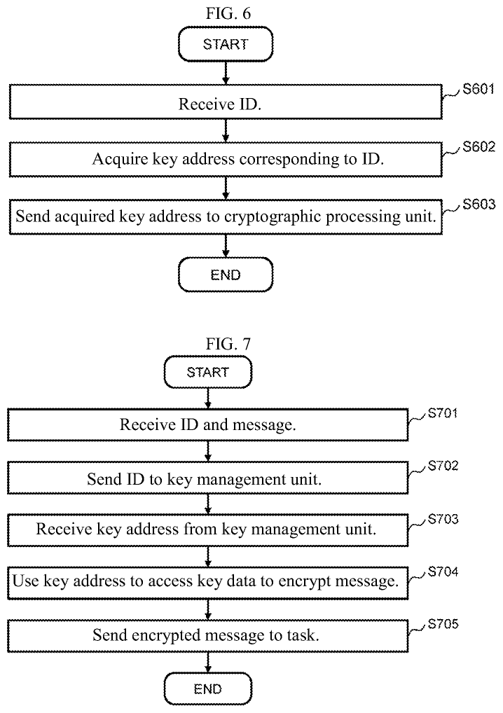

The cryptographic processing unit 128 carries out the cryptographic process (Step S325) upon receipt of the key address that is sent from the key management unit 124. A message, for example, is encrypted by the cryptographic process. Note that the cryptographic process will be described below using FIG. 7.

The cryptographic processing unit 128 sends the encrypted message to the task 127 (Step S326). Note that the task 127 sends the encrypted message to the outside.

FIG. 4 is a diagram showing an example of a flowchart relating to the key registration process carried out by the key management unit 124.

In Step S401, the key management unit 124 receives the ID and the obfuscated key data from the task 127.

In Step S402, the key management unit 124 uses an obfuscation tool to remove the obfuscation from the obfuscated key data to produce the key data 126, and stores it in a prescribed location (for example, a location selected at random) in the key management space 122 of the storage unit 120.

In Step S403, the key management unit 124 registers key address management information 125 that defines the correspondence between the received ID and the address that indicates the prescribed location (the key address) wherein the key data 126, having had the obfuscation removed from the obfuscated key data that had been received, is stored.

FIG. 5 is a diagram showing an example of a flowchart relating to the key moving process that is carried out by the key management unit 124. The key moving process is repeated for each key data 126.

In Step S501, the key management unit 124 evaluates whether or not the time (hereinafter termed “holding time”) over which the key data 126 has been stored (held) in the same location (a first storing location) has reached a first time. If the key management unit 124 evaluates that the holding time has reached the first time, processing advances to Step S502, but if the evaluation is that the holding time has not reached the first time, processing is terminated. Note that the structure is such that the first time is set by the administrator of the key management device 100 (hereinafter termed “system administrator”). Moreover, the structure may be such that the first time can be set for each individual task 127, depending on the characteristics of the task 127. This structure enables the first time to be set depending on the degree of concealment of the communication, depending on the task 127, and enables the first time to be set depending on the frequency of the communication, depending on the task 127.

In Step S502, the key management unit 124 copies the key data 126 to another location (a second storage region that is separate from the first storage region) at random.

In Step S503, the key management unit 124 updates the key address management information 125 with the address of the other location (the second storage region). Note that the first storing region is the source from which copying is performed (the copy source) and the second storage region is the destination for copying (the copy destination).

In Step S504, the key management unit 124 evaluates whether the time over which the key data 126 exists redundantly in the key management space 122 (hereinafter termed “redundancy time”) has reached a second time. If the key management unit 124 evaluates that the redundancy time has reached the second time, processing advances to Step S505, but if the evaluation is that the redundant time has not reached the second time, processing returns to Step S504. Note that the structure may be such that the second time can be set by the system administrator. Additionally, the structure may be such that the second time can be set for each individual task 127.

In Step S505, the key management unit 124 clears the key data 126 of the copying source (the first storage region), and terminates the process.

FIG. 6 is a diagram showing an example of a flowchart relating to a key address acquiring process carried out by the key management unit 124.

In Step S601, the key management unit 124 receives an ID from the cryptographic processing unit 128.

In Step S602, the key management unit 124 references the key address management information 125 to acquire the key address that corresponds to the ID that has been received.

In Step S603, the key management unit 124 sends, to the cryptographic processing unit 128, the key address that has been acquired.

FIG. 7 is a diagram showing an example of a flowchart relating to a cryptographic process (which, in the present example, is encryption), carried out by the cryptographic processing unit 128.

In Step S701, the cryptographic processing unit 128 receives an ID and a message from a task 127.

In Step S702, the cryptographic processing unit 128 sends the received ID, as address request information, to the key management unit 124.

In Step S703, the cryptographic processing unit 128 receives the key address from the key management unit 124.

In Step S704, the cryptographic processing unit 128 uses the key address to access the key data 126 to encrypt the message.

In Step S705, the cryptographic processing unit 128 sends the encrypted message to the task 127 that corresponds to the ID that has been received.

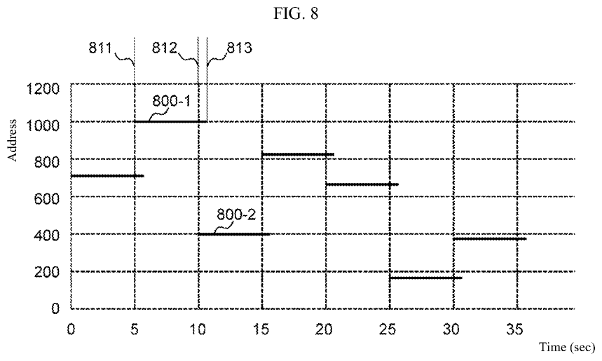

FIG. 8 is a diagram for explaining movement of the key data 126.

As illustrated in FIG. 8, the location (address) wherein the key data 126 is stored is changed randomly at constant time intervals (for example, every 5 seconds).

Here 800-1 indicates the time (holding time) over which the key data 126 is stored in address “1000.” Time 811 indicates the time at which the key data 126 is stored into address “1000.” Time 812 indicates the time at which a given time interval (the first time) has elapsed after time 811. Time 813 indicates the time at which a given time interval (the second time) has elapsed from time 812.

Additionally, interval 800-2 indicates the time interval over which key data 126 is stored in address “400.”

During the time interval from time 812 to time 813 (the redundancy time) the key data 126 exists at address “1000” and address “400.” The redundancy time is set to avoid a situation wherein access to the key data 126 fails due to the key data 126 not being present at address “1000” when the address “1000” is to be used to access the key data 126 through the cryptographic processing unit 128 sending address request information at time 812 and acquiring address “1000.”

However, if key data 126 is left stored in address “1000,” there would be the risk that the key data 126 could be obtained if an unauthorized user were to illegally access the address “1000.” Because of this, the key data 126 is cleared from address “1000” after the second time has elapsed. Note that the second time may be set based on the experience of the system administrator, or may be set through an automatic calculation of the average time at which task 127 completes encryption after transmission of the address request information.

The present embodiment enables appropriate management of key data, without changing the key data.

### (2) Addendum

Content such as set forth below, for example, is included in the embodiment set forth above.

While in the embodiment set forth above, the present invention was described for a case of application to a key management device, the present invention is not limited thereto, but rather may be applied broadly to other types of systems (for example, car navigation systems), devices (for example, vehicle-mounted devices), and methods.

Moreover, while in the embodiment set forth above the OS space 121 and the key management space 122 were explained as different spaces, the present invention is not limited to this structure. For example, some or all of the key management space 122 may be included in the OS space 121.

While in the embodiment set forth above the explanation was for a case wherein the cryptographic processing unit 128 is provided in the user space 123, the present invention is not limited to this structure. For example, the cryptographic processing unit 128 may be a function provided by the OS, and may be provided in the OS space 121.

Additionally, in the embodiment set forth above, each table is an example of information, and a single table may be divided into two or more tables, and all or part of two or more tables may be a single table. Moreover, in the embodiment set forth above at least a portion of the information may be information of any structure (for example, may be structured data or may be unstructured data), and may be a learned model, such as a neural network, that produces outputs in relation to inputs.

Moreover, while in the embodiment set forth above functions were explained expressed as “kkk units,” the functions may be achieved through execution of one or more computer programs by a control device (processor), may be achieved through one or more hardware circuits (such as, for example, FPGAs or ASICs), or may be achieved through a combination thereof. When a function is achieved through execution of one or more programs by a control device, specific processes are carried out using storage devices and/or communication devices as appropriate, and thus a “function” may be defined as at least a portion of the control device. A process described with a function as the subject may be a process that is carried out by a control device or by a device that includes that control device. The program may be installed from a program source. The program source may be, for example, a computer for distributing programs or a computer readable recording medium (for example, a non-volatile recording medium). The act explanations of individual functions are examples, where a plurality of functions may be combined into a single function, and a single function may be divided into a plurality of functions.

Moreover, in the explanation set forth above, the information, such as programs, tables, files, and the like, regarding each function may be placed on a storage device such as a memory, a hard disk, an SSD (solid-state drive), or the like, or placed on a recording medium such as an IC card, an SD card, a DVD, or the like.

The embodiment set forth above has the distinctive features set forth below, for example.

A key management device (for example, the key management device 100) for managing key data using a cryptographic process (encryption, decryption, or the like) on a message (for example, data for communication), comprising: a key management unit (for example, the key management unit 124) for managing key data using key address management information (for example, the key address management information 125) that is included at an address (for example, a physical address) that indicates a location wherein key data (for example, the key data 126) is stored; a cryptographic processing unit (for example, the cryptographic processing unit 128) for using key data, controlled through the key management unit, to carry out a cryptographic process on a message, wherein: the key management unit stores, with prescribed timing, the controlled key data into a second address that is different from a first address that indicates a location wherein the key data is stored (for example, Step S502), and updates the first address of the key address management information to a second address (for example, Step S503); the cryptographic processing unit sends, to the key management unit, address request information for requesting an address for key data for carrying out a cryptographic process on a prescribed message (for example, Step S702); the key management unit, upon receipt of the address request information, acquires the address for the key data from the key address management information and sends it to the cryptographic processing unit (for example, Step S601 through Step S603); and the cryptographic processing unit, upon receipt of the address, accesses the address to use the key data to perform the cryptographic process on the message (for example, Step S704).

In the structure set forth above, when using key data the address of the key data is accessed to perform the cryptographic process on the message, and the address of the key data is changed, making it difficult for an unauthorized user to discover the address of the key data. For example, in a structure that accesses the address of the key data when performing the cryptographic process on the message, controlling so as to change the address of the key data makes it difficult to know where the key data is, and where the key data begins and ends, even if an unauthorized user were to acquire a memory dump. In this way, the structure set forth above makes it possible to reduce situations wherein an unauthorized user is able to obtain key data, even without changing the key data itself.

The key management unit may instead change the location for storing the key data (the storing destination) randomly, or the change may follow a sequence or rule designated in advance by the system administrator (for example, a specific sequence such as address “100,” address “200,” address “300”).

In the key management unit, the timing for changing the location for storing the key data (the timing for changing the location wherein the key data is stored) may be periodic or it may be irregular, or it may be immediately after the key data is accessed (for example, after cryptographic processing of a message using the key data).

The key management unit preferably clears or changes the key data that was at an address prior to the change (“pre-change address”). If the structure is one wherein key data that was the pre-change address is cleared, then even if an unauthorized user were to acquire the address of the key data, the unauthorized user would fundamentally be unable to acquire the key data because the key data will no longer be at the pre-change address. Conversely, if the structure is one wherein the key data at the address from prior to a change is changed, then even if the unauthorized user were to acquire the address of the key data, data that is different from the key data would be acquired from the pre-change address, fundamentally preventing acquisition of the key data.

In the structures set forth above, the key data may be obfuscated or non-obfuscated.

The key management unit changes, at random, the location of the destination for storing the key data (for example, Step S502 and FIG. 8).

In the structure set forth above, the location for storing the key data is changed at random, for example, making it difficult for an unauthorized user to infer or find the key data from an address in the past, making it possible to maintain data security.

The cryptographic processing unit sends obfuscated key data to the key management unit (for example, Step S303), and the key management unit clears the obfuscation of the obfuscated key data, producing the key data, and the key data is stored at a prescribed location (for example, Step S402), and the address of the location is registered in the key address management information (for example, Step S403).

In the structure set forth above, the key data that is required for cryptographic processing of a message is sent in an obfuscated state from the cryptographic processing unit to the key management unit, the obfuscation is cleared by the key management unit, and the key data is registered. In this way, by the cryptographic processing unit passing obfuscated key data to the key management unit, an unauthorized user is prevented from using key data easily, even if the unauthorized user were to acquire the key data at the time that the key data is received.

In the structure set forth above, obfuscated key data that is instead used in common in a plurality of tasks that carry out communication with the outside may be written in the source code of the cryptographic processing unit, or obfuscated key data may be written corresponding to individual tasks that carry out communication with the outside, or obfuscated key data may be sent from each individual task that is to carry out communication with the outside.

Upon receipt, from a task that carries out communication with the outside (for example, the task 127), of identifying information corresponding to a task (for example, an ID) and obfuscated key data that is written in the source code of the task, the cryptographic processing unit sends the identifying information and the obfuscated key data to the key management unit (for example, Step S303); the key management unit clears the obfuscation of the obfuscated key data, producing the key data, stores this key data into a prescribed location, and registers, in the key address management information, the correspondence between the identifying information and the address of the location (for example, Step S402 and Step S403); the cryptographic processing unit, upon receipt, from the task, of identifying information for the task and a message relating to communication (for example, Step S701), sends the identifying information, as address request information, to the key management unit (for example, Step S702); the key management unit, upon receipt of the identifying information (for example, Step S601), acquires, from the key address management information, the address corresponding to the identifying information, and sends it to the cryptographic processing unit (for example, Step S602 and Step S603); and the cryptographic processing unit, upon receipt of the address (for example, Step S703), accesses the address to use the key data to carry out the cryptographic processing on the message, and sends it to the task (for example, Step S704 and Step S705).

In the structure set forth above, the key data required for cryptographic processing of a message in communication by a task is sent to the key management unit through the cryptographic processing unit from the task in an obfuscated state, and key data from which the obfuscation has been cleared is registered in the key management unit. The task passing obfuscated key data to the key management unit in this way prevents the key data from being used easily even if an unauthorized user were to acquire the key data when the key data is passed. Moreover, when compared to managing key data in common for all tasks, controlling the key data by individual task makes it more difficult for an unauthorized user to acquire key data for a desired task.

The key management unit clears the key data at the first address after storing into the second address (for example, Step S502 and Step S505).

In the structure set forth above, even if, for example, an unauthorized user were to acquire a pre-change address, the key data of that address is cleared, making it possible to reduce situations wherein an unauthorized user can obtain key data.

Appropriate timing may be used for the timing of clearing of the key data at the first address. For example, the key management unit may clear the key data at the pre-change address immediately. In this case, if, for example, the cryptographic processing unit fails to acquire key data by accessing the key data with the timing with which the address is changed, a retry may be carried out. Moreover, the key data at the pre-change address may be cleared when, for example, the key management unit has evaluated that the number of key data of identical content has reached a prescribed number (for example, 2).

The key management unit clears the key data at the first address upon evaluation that a prescribed time (for example, a second time) has elapsed after storing the key data into a second address (referencing, for example, Step S504, Step S505, and FIG. 8).

If here the location wherein the key data is stored is changed between the cryptographic processing unit acquiring the address and performing the cryptographic processing, the cryptographic processing unit will be unable to access the key data. In regard to this point, in the structure set forth above, providing a time interval over which the key data is stored at both a pre-change address and a post-change address makes it possible to avoid, for example, a situation wherein the cryptographic processing unit is unable to access the key data.

The structures set forth above may be modified, combined, recombined, or omitted as appropriate in a scope that does not exceed the spirit and intent of the present invention.

The contents disclosed in the following priority basic application are incorporated here by reference: Japanese Patent Application 2019-206363 (filed on Nov. 14, 2019)

### EXPLANATIONS OF REFERENCE SYMBOLS

100: Key Management Device
124: Key Management Unit
128: Cryptographic Processing Unit

What is claimed is:

1. A key management device for managing key data used in cryptographic processing of a message, comprising:
a key management unit for managing key data using key address management information that includes an address indicating a location wherein key data is stored; and
a cryptographic processing unit for performing a cryptographic process on a message using the key data that is managed by the key management unit, wherein:
the key management unit stores the managed key data at a second address with prescribed timing, the second address is different from a first address that indicates a location wherein the key data is stored, and updates the first address in the key address management information to the second address;
the cryptographic processing unit transmits address request information for requesting the key data address to the key management unit in order to perform cryptographic processing on a prescribed message;
the key management unit, upon receipt of the address request information, acquires the key data address from the key address management information, and transmits the acquired key data address to the cryptographic processing unit; and
the cryptographic processing unit, upon receipt of the address, performs cryptographic processing on the message by accessing the address and using the key data.

2. A key management device set forth in claim 1, wherein:
the key management unit changes at random the location for storing the key data.

3. A key management device set forth in claim 1, wherein:
the cryptographic processing unit transmits obfuscated key data to the key management unit; and
the key management unit produces the key data by clearing the obfuscation of the obfuscated key data, stores the key data into a prescribed location, and registers the address of the location in key address management information.

4. A key management device set forth in claim 1, wherein:
the cryptographic processing unit, upon receipt, from a task that carries out communication with the outside, of identifying information corresponding to the aforementioned task and obfuscated key data that is written in the source code of the task, transmits the identifying information and the obfuscated key data to the key management unit;
the key management unit produces key data by clearing the obfuscation from the obfuscated key data, and stores the key data into a prescribed location, and defines, and registers in the key address management information, a correspondence between the identifying information and the location address;
the cryptographic processing unit, upon receipt of identifying information for the task and a message for communication from the task, transmits the identifying information, as the address request information, to the key management unit;
the key management unit, upon receipt of the identifying information, acquires, from the key address management information, the address corresponding to the identifying information, and transmits it to the cryptographic processing unit; and
the cryptographic processing unit, upon receipt of the address, accesses the address to use the key data to carry out cryptographic processing on the message, and transmits it to the task.

5. A key management device set forth in claim 1, wherein:
the key management unit, after storing into the second address, clears the key data at the first address.

6. A key management device set forth in claim 5, wherein:
the key management unit, upon evaluation that a prescribed time has elapsed after storing the key data into the second address, clears the key data at the first address.

7. A key management method for managing key data used in cryptographic processing of a message, including:
a key management unit managing key data using key address management information that includes an address indicating a location wherein key data is stored; and
a cryptographic processing unit performing a cryptographic process on a message using the key data that is managed by the key management unit, wherein:
the key management unit stores the key managed data at a second address with prescribed timing, the second address is different from a first address that indicates a location wherein the key data is stored, and updates the first address in the key address management information to the second address;
the cryptographic processing unit transmits address request information for requesting the key data address to the key management unit in order to perform cryptographic processing on a prescribed message;
the key management unit, upon receipt of the address request information, acquires the key data address from the key address management information, and transmits the acquired key data address to the cryptographic processing unit; and
the cryptographic processing unit, upon receipt of the address, performs cryptographic processing on the message by accessing the address and using the key data.

8. A key management method set forth in claim 7, wherein:
the key management unit changes at random the location for storing the key data.

9. A key management method set forth in claim 7, wherein:
the cryptographic processing unit transmits obfuscated key data to the key management unit; and
the key management unit produces the key data by clearing the obfuscation of the obfuscated key data, stores the key data into a prescribed location, and registers the address of the location in key address management information.

10. A key management method set forth in claim 7, wherein:
the cryptographic processing unit, upon receipt, from a task that carries out communication with the outside, of identifying information corresponding to the aforementioned task and obfuscated key data that is written in the source code of the task, transmits the identifying information and the obfuscated key data to the key management unit;
the key management unit produces key data by clearing the obfuscation from the obfuscated key data, and stores the key data into a prescribed location, and defines, and registers in the key address management information, a correspondence between the identifying information and the location address;
the cryptographic processing unit, upon receipt of identifying information for the task and a message for communication from the task, transmits the identifying information, as the address request information, to the key management unit;
the key management unit, upon receipt of the identifying information, acquires, from the key address management information, the address corresponding to the identifying information, and transmits it to the cryptographic processing unit; and
the cryptographic processing unit, upon receipt of the address, accesses the address to use the key data to carry out cryptographic processing on the message, and transmits it to the task.

11. A key management method set forth in claim 7, wherein:
the key management unit, after storing into the second address, clears the key data at the first address.

12. A key management method set forth in claim 11, wherein:
the key management unit, upon evaluation that a prescribed time has elapsed after storing the key data into the second address, clears the key data at the first address.
